(19) United States
(12) Patent Application Publication
(10) Pub. No.: US 2008/0314872 A1
(43) Pub. Date: Dec. 25, 2008

(54) Chemical-Mechanical Polishing Compositions Containing Aspartame And Methods Of Making And Using The Same

(75) Inventors: Yue Liu, Pittsford, NY (US); Brian Santora, Penn Yan, NY (US)

Correspondence Address: RANKIN, HILL & CLARK LLP, 925 EUCLID AVENUE, SUITE 700, CLEVELAND, OH, 44115-1405, US

(73) Assignee: FERRO CORPORATION, Cleveland, OH (US)

(21) Appl. No.: 12/104,798

(22) Filed: Apr. 17, 2008

Related U.S. Application Data
(60) Provisional application No. 60/944,905, filed on Jun. 19, 2007.
(60) Provisional application No. 60/991,865, filed on Dec. 3, 2007.

(51) Int. Cl. C09K 13/06; B44C 1/22

(52) U.S. Cl. 216/53; 252/79.1

(57) ABSTRACT

The present invention provides an aqueous CMP slurry composition that comprises abrasive particles and Aspartame. The CMP slurry composition according to the invention is selective for polishing silicon dioxide in preference to silicon nitride from a surface of an article by chemical mechanical planarization. Furthermore, as more Aspartame is added to the slurry, the silicon dioxide rate is either not greatly affected or increases and the silicon nitride rate stays extremely low. In addition to offering selectivity of silicon dioxide to silicon nitride polishing, the present invention provides a method of using Aspartame as a polish accelerant in silicon dioxide polishing.

### PRIORITY CLAIM

This application claims priority to U.S. Provisional Application Ser. Nos. 60/944,905, filed Jun. 19, 2007, and 60/991,865, filed Dec. 3, 2007, both of which are hereby incorporated by reference in their entirety.

### BACKGROUND OF INVENTION

1. Field of Invention

The present invention relates to chemical-mechanical polishing (“CMP”) compositions and methods of making and using the same.

2. Description of Related Art

CMP is a technology that has its roots in the pre-industrial era. In recent years, CMP has become the technology of choice among semiconductor chip fabricators to planarize the surface of semiconductor chips as circuit pattern layers are laid down. CMP technology is well-known, and is typically accomplished using a polishing pad and a polishing slurry composition that contains a chemical reagent and abrasive particles. The chemical reagent functions to chemically react with one or more materials on the surface of the layer being polished whereas the abrasive particles perform a mechanical grinding function.

One of the uses of CMP technology is in the manufacture of shallow trench isolation (STI) structures in integrated circuits formed on semiconductor chips or wafers such as silicon. The purpose of an STI structure is to isolate discrete device elements (e.g., transistors) in a given pattern layer to prevent current leakage from occurring between them. Recent technological advancements that facilitate the fabrication of very small, high density circuit patterns on integrated circuits have placed higher demands on isolation structures.

An STI structure is usually formed by thermally growing an oxide layer on a silicon substrate and then depositing a silicon nitride layer on the thermally grown oxide layer. After deposition of the silicon nitride layer, a shallow trench is formed through the silicon nitride layer, the thermally grown oxide layer and partially through the silicon substrate using, for example, any of the well known photolithography masking and etching processes. A layer of a dielectric material such as silicon dioxide is then typically deposited using a chemical vapor deposition process to completely fill the trench and cover the silicon nitride layer. Next, a CMP process is used to remove that portion of the silicon dioxide layer that overlies or covers the silicon nitride layer and to planarize the entire surface of the workpiece. The silicon nitride layer is intended to function as a polishing stop that protects the underlying thermally grown oxide layer and silicon substrate from being exposed during CMP processing. In some applications, the silicon nitride layer is later removed by, for example, dipping the article in a hot phosphoric acid solution, leaving only the silicon dioxide filled trench to serve as an STI structure. Additional processing is usually then performed to form polysilicon gate structures.

It should be readily apparent that during the CMP step of manufacturing an STI structure on a silicon semiconductor substrate, it would be highly advantageous to use a polishing agent that is capable of selectively removing silicon dioxide in preference to silicone nitride, which is used as the stop layer. Ideally, the rate at which silicon nitride is removed by CMP would be nil, whereas the rate at which the silicon dioxide overlying the silicon nitride stop layer is removed by CMP would be very high. This would allow high manufacturing throughput. The term “selectivity” is used to describe the ratio of the rate at which silicon dioxide is removed to the rate at which silicon nitride is removed by the same polishing agent during a CMP process. Selectivity is determined by dividing the rate at which the silicon dioxide film is removed (usually expressed in terms of Å/min) by the rate at which the silicon nitride film is removed.

It is known that the removal rate of the silicon dioxide trench fill material can be made to be quite high by varying polishing conditions such as increasing pad pressure and using larger abrasive particles in the slurry. However, these polishing conditions also tend to increase the silicon nitride removal rate, which can affect the uniformity of the final silicon nitride layer thickness and can cause other defects, such as scratching, in the final product. Thus, it is important for a CMP slurry composition to promote a reasonable silicon dioxide removal rate while, at the same time, inhibiting or suppressing the rate of silicon nitride removal. This too, however, must be done in moderation for some applications. When the selectivity of a CMP slurry is too high coupled with a very low silicon nitride removal rate, other problems such as “dishing” of the trench silicon dioxide can occur, which can result in severe topography variations once the silicon nitride stop layer is removed. Thus, a CMP slurry composition needs to be able to balance these factors in order to be useful in STI processing.

In the past, polyacrylates and certain amino acids have been added to CMP slurry compositions to obtain highly selective polishing of silicon dioxide in preference to silicon nitride. In most prior art CMP slurry compositions that employ these additives, as more of the additive is added, both the silicon dioxide and silicon nitride removal rate decreases. This can be problematic in some instances where removal rate on silicon dioxide is too slow, thereby decreasing manufacturing throughput on shallow trench isolation (STI) structures.

### BRIEF SUMMARY OF THE INVENTION

The present invention provides an aqueous CMP slurry composition that comprises abrasive particles and N-L-α-aspartyl-L-phenylalanine-1-methyl ester (hereinafter “Aspartame”). The CMP slurry composition according to the invention is selective for polishing silicon dioxide in preference to silicon nitride from a surface of an article by chemical mechanical planarization. Furthermore, as more Aspartame is added to the slurry (i.e., the Aspartame concentration of the slurry increases), the silicon dioxide rate is either not greatly affected or increases and the silicon nitride rate stays extremely low. In addition to offering selectivity of silicon dioxide to silicon nitride polishing, the present invention provides a method of using Aspartame as a polish accelerant in silicon dioxide polishing, especially when topography is present on the wafer surface.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### BRIEF DESCRIPTION OF THE DRAWING

FIG. 1 is a graph showing removal rate as a function of time for various CMP slurry compositions formed in the accompanying Examples.

### DETAILED DESCRIPTION OF THE INVENTION

In one embodiment, the present invention provides CMP slurry compositions and methods that facilitate the removal of silicon dioxide in preference to silicon nitride via chemical-mechanical polishing during semiconductor device fabrication. The term “silicon dioxide” refers to any deposit having predominantly the structure of SiO₂, which may have been deposited or formed by any means including, but not limited to, thermally grown silicon dioxide.

CMP slurry compositions according to the invention comprise aqueous dispersions of abrasive particles, Aspartame (N-L-α-Aspartyl-L-phenylalanine-1-methyl ester) and a sufficient amount of a pH adjusting material to adjust the pH of the CMP slurry composition within the range of from about 3 to about 11, and most preferably within the range of from about 3.5 to about 8.0.

The abrasive particles used in the CMP slurry composition according to the present invention perform the function of mechanical grinding. The preferred abrasive particles for use in the invention are formed of ceria. It may be possible to use other abrasive particles such as, for example, alumina, silica, copper oxide, iron oxide, nickel oxide, manganese oxide, silicon carbide, silicon nitride, tin oxide, titania, titanium carbide, tungsten oxide, yttria, zirconia, and combinations thereof, provided such abrasives provide an acceptable polishing rate.

The preferred ceria abrasive particles preferably have a mean diameter (secondary particle size) ranging from about 20 nm to about 1000 nm, with a maximum diameter of less than about 10,000 nm. If the mean diameter of the abrasive particles is very small, the polishing rate of the CMP slurry composition can be unacceptably low. If the mean diameter of the abrasive particles is large, unacceptable scratching can occur on the surface of the article being polished. Abrasive particles consisting of ceria having a mean diameter within the range of from about 100 nm to less than 150 nm are presently believed to be optimal.

The abrasive particles can be dispersed in water as discrete particles before polishing to form a slurry, which is then disposed between a polishing pad and a surface of a workpiece. Alternatively, the abrasive particles can initially be bonded to the polishing pad, and the CMP slurry composition can be formed in situ by dissociation of the abrasive particles from the polishing pad during polishing of the surface of the workpiece.

When dispersed to form an aqueous CMP slurry composition prior to polishing, the abrasive particles are preferably present in the CMP slurry composition in an amount of from about 0.05% to about 8% by weight of the CMP slurry composition, more preferably from about 0.5% to about 6% by weight of the CMP slurry composition, and most preferably from about 1.0% to about 4%, or about 3.0%, by weight of the CMP slurry composition.

Aspartame performs the function of suppressing the removal rate of silicon nitride during polishing. Preferably, Aspartame is present in an amount of from about 0.005% to about 1.5% by weight of the CMP slurry composition, with the optimal range presently believed to be from about 0.1% to about 1.0% by weight of the CMP slurry composition.

CMP slurry compositions according to the present invention exhibit high selectivity of silicon dioxide to silicon nitride over a pH range of about 3 to about 11. Preferably, however, the pH of the CMP slurry composition is adjusted within the range of from about 3.5 to about 8.0 using a pH adjusting compound such as nitric acid. It will be appreciated that the pH of the CMP slurry composition be adjusted by the addition of acids and/or bases. Nitric acid is the presently preferred acid for lowering the pH of the CMP slurry composition, and potassium hydroxide and ammonium hydroxide are preferred bases for increasing the pH of the CMP slurry composition. It will be appreciated that the selection of a pH adjuster is not critical, and that other acids and bases can be used in the practice of the invention. The CMP slurry composition may also contain optional surfactants, pH buffers, anti-foaming agents, and dispersing agents, which are well known.

It will be appreciated that CMP slurry compositions according to the invention can be “tuned” within the foregoing ranges to optimize performance for a particular patterned wafer configuration. To tune CMP slurry compositions, one can estimate the amount of silicon dioxide to be removed from the patterned wafer over a given unit of time, and then adjust the Aspartame content, ceria size and content, and pH of the slurry to provide the optimal patterned wafer removal rate, while minimizing field oxide dishing and nitride erosion. Generally speaking, increasing the amount of Aspartame in the CMP slurry composition tends to suppress the rate of silicon nitride removal. Increasing the size and/or content of the abrasive tends to increase the rate at which silicon dioxide is removed. Raising the pH of the CMP slurry composition tends to increase the removal rate for both silicon dioxide and silicon nitride.

The present invention also provides a method of removing silicon dioxide in preference to silicon nitride. The method comprises providing a CMP slurry composition as described above between a polishing pad and a surface of the workpiece, and pressing the polishing pad and the surface of the workpiece together with the CMP slurry composition disposed therebetween while the polishing pad and the surface of the workpiece are moving relative to each other to remove silicon dioxide from the surface of the workpiece. Preferably, silicon dioxide is removed at a rate that is greater than 1000 Å/min and at least twenty-five times greater than a rate at which silicon nitride is removed from the surface of the workpiece.

The present invention also provides a method for increasing the step height removal rate (SHRR) for silicon dioxide polishing, which is especially effective in inner layer dielectric (ILD) polishing and bulk-oxide-removal in shallow trench isolation (STI) structures. The method comprises adding Aspartame to CMP formulations or ensuring that Aspartame is present in such CMP formulations. When present in such compositions, Aspartame acts as a polish accelerant, which increases the silicon dioxide SHRR. This can be an advantage in CMP as it will increase wafer throughput during manufacturing.

CMP slurry compositions and methods of the present invention can be used to planarize patterned wafers during the fabrication of semiconductor chips. In such applications, CMP slurry compositions and methods provide benefits over prior art CMP slurry compositions and methods in terms of removal rate, selectivity, field oxide dishing and meeting minimal defectivity requirements. The CMP slurry compositions may also be useful in other polishing applications such as, for example, glass polishing, polishing of organic polymer-based ophthalmic substrates and in metal polishing.

The following examples are intended only to illustrate the invention and should not be construed as imposing limitations upon the claims.

### EXAMPLE 1

CMP Slurry Compositions A1, A2 and A3 were prepared as shown in weight percent in Table 1 below.

TABLE 1

| Slurry | CeO₂ | Aspartame | DI-H₂O | pH |
|---|---|---|---|---|
| A1 | 1% | 0% | 99% | 4.32 |
| A2 | 1% | 0.3% | 98.7% | 4.32 |
| A3 | 1% | 0.5% | 98.5% | 4.32 |

The “CeO2” used in each CMP Slurry Composition was a calcined cerium oxide derived from a cerium carbonate precursor that had a Dₘₑₐₙ secondary particle size of 140 nm. A quantity of HNO₃ was added to each CMP Slurry Composition sufficient to adjust the pH to 4.32. CMP Slurry Composition A1 was a control in that it did not contain any Aspartame.

CMP Slurry Compositions A1, A2 and A3 were separately used to polish blanket thermally grown silicon dioxide (“TOX”) and silicon nitride wafers (“Nitride”). The polisher used in each case was an Applied Materials Mirra system. For all test runs, the polishing conditions were 3.0 psi membrane pressure, 3.5 psi retaining ring pressure, 3.0 psi inner tube pressure, 93 rpm head speed and 87 rpm table speed. The flow rate of the CMP Slurry Compositions was 150 ml/min. in each case. The polishing pad used in each case was a Rohm & Haas k-grooved IC 000 pad, with a Suba IV backing. The removal rate (“RR”) of each material in Å/min is set forth in Table 2 together with the selectivity for removing silicon dioxide in preference to silicon nitride (TOX RR/Nitride RR):

TABLE 2

| Slurry | TOX RR | Nitride RR | Selectivity |
|---|---|---|---|
| A1 | 3104.2 | 1049.2 | 3 |
| A2 | 3090.8 | 98.2 | 31 |
| A3 | 2801.3 | 7.2 | 389 |

Example 1 shows that as more Aspartame is added to 1% ceria formulations at a pH of about 4.3, the selectivity increases without significantly decreasing silicon dioxide removal rate (TOX RR).

### EXAMPLE 2

CMP Slurry Compositions B1, B2 and B3 were prepared as shown in weight percent in Table 3 below.

TABLE 3

| Slurry | CeO₂ | Aspartame | DI-H₂O | pH |
|---|---|---|---|---|
| B1 | 3% | 0% | 97% | 4.04 |
| B2 | 3% | 0.3% | 96.7% | 4.04 |
| B3 | 3% | 0.5% | 96.5% | 4.04 |

The “CeO2” used in each CMP Slurry Composition was the same as used in Example 1. A quantity of HNO₃ was added to each CMP Slurry Composition sufficient to adjust the pH to 4.04. CMP Slurry Composition B1 was a control in that it did not contain any Aspartame.

CMP Slurry Compositions B1, B2 and B3 were separately used to polish blanket thermally grown silicon dioxide and silicon nitride wafers using the equipment and polishing conditions described in Example 1. The removal rate of each material in Å/min and silicon dioxide to silicon nitride selectivity is set forth in Table 4:

TABLE 4

| Slurry | TOX RR | Nitride RR | Selectivity |
|---|---|---|---|
| B1 | 1936.9 | 1439.1 | 1 |
| B2 | 2852.4 | 18.0 | 158 |
| B3 | 2562.2 | 10.9 | 235 |

Example 2 shows that at 3% ceria and at pH of about 4.0, the selectivity increases with Aspartame additions and even has an increased removal rate of silicon dioxide in the presence of the Aspartame additive.

### EXAMPLE 3

CMP Slurry Compositions C1, C2 and C3 were prepared as shown in weight percent in Table 5 below.

TABLE 5

| Slurry | CeO2 | Aspartame | Water | pH |
|---|---|---|---|---|
| C1 | 1 | 0 | 99 | 3.9 |
| C2 | 1 | 0.1 | 98.9 | 4.4 |
| C3 | 1 | 0.4 | 98.6 | 4.0 |

The “CeO2” used in each CMP Slurry Composition was the same as used in Example 1. CMP Slurry Composition C1 was a control in that it did not contain any Aspartame.

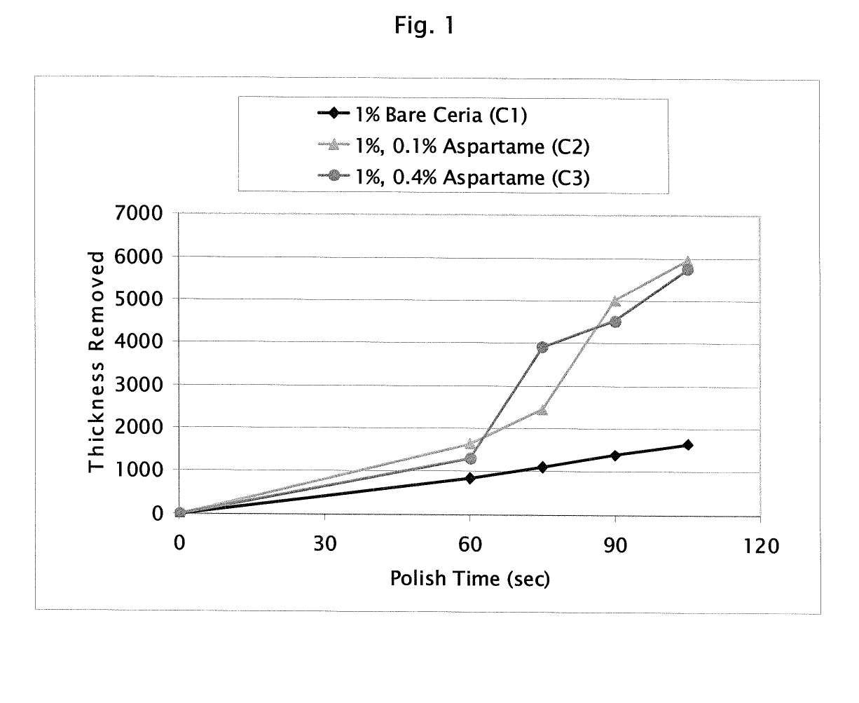

CMP Slurry Compositions C1, C2 and C3 were separately used to polish patterned high density plasma (HDP) silicon dioxide films using the equipment and polishing conditions described in Example 1. The amount of up area removed (active removal rate, ACT Removed) of each material removed in Å for different polish times is set forth in Table 6 and further illustrated in FIG. 1:

TABLE 6

| | C1 | C2 | C3 |
|---|---|---|---|
| Time | ACT Removed | ACT Removed | ACT Removed |
| 0 | 0 | 0 | 0 |
| 60 | 840 | 1309 | 1642 |
| 75 | 1102 | 3919 | 2454 |
| 90 | 1394 | 4537 | 5019 |
| 105 | 1644 | 5756 | 5962 |

Example 3 shows that at 1% ceria and at a pH of about 4.0, the silicon dioxide step height removal rate is increased with Aspartame additions.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1. An aqueous CMP slurry composition comprising abrasive particles and Aspartame.

2. The aqueous CMP slurry composition according to claim 1 wherein the CMP slurry composition comprises from about 0.005% to about 1.5% Aspartame by weight.

3. The aqueous CMP slurry composition according to claim 1 wherein the CMP slurry composition comprises from about 0.1% to about 1.0% Aspartame by weight.

4. The aqueous CMP slurry composition according to claim 1 wherein the aqueous CMP slurry composition has a pH of from about 3 to about 11.

5. The aqueous CMP slurry composition according to claim 1 wherein the aqueous CMP slurry composition has a pH of from about 3.5 to 8.0.

6. The aqueous CMP slurry composition according to claim 1 wherein the abrasive particles comprise ceria.

7. The aqueous CMP slurry composition according to claim 6 wherein the ceria abrasive particles have a mean diameter of from about 20 nm to about 1000 nm.

8. The aqueous CMP slurry composition according to claim 7 wherein the ceria abrasive particles have a maximum diameter of less than about 10,000 nm.

9. The aqueous CMP slurry composition according to claim 6 wherein the ceria abrasive particles have a mean diameter of from about 100 nm to about 150 nm.

10. The aqueous CMP slurry composition according to claim 1 wherein the abrasive particles are dispersed in water prior to polishing.

11. The aqueous CMP slurry composition according to claim 1 wherein the abrasive particles are initially bonded to a polishing pad and become dispersed in water during polishing.

12. The aqueous CMP slurry composition according to claim 1 wherein the abrasive particles are present in the CMP slurry composition in an amount of from about 0.05% to about 8% by weight of the CMP slurry composition.

13. The aqueous CMP slurry composition according to claim 1 wherein the abrasive particles are present in the CMP slurry composition in an amount of from about 0.5% to about 6% by weight of the CMP slurry composition.

14. The aqueous CMP slurry composition according to claim 1 wherein the abrasive particles are present in the CMP slurry composition in an amount of from about 1% to about 4% by weight of the CMP slurry composition.

15. The aqueous CMP slurry composition according to claim 1 wherein the abrasive particles are selected from the group consisting of ceria, alumina, silica, copper oxide, iron oxide, nickel oxide, manganese oxide, silicon carbide, silicon nitride, tin oxide, titania, titanium carbide, tungsten oxide, yttria, zirconia, and combinations thereof.

16. A method for removing at least a portion of a surface material from a workpiece by chemical mechanical polishing, the method comprising:
providing an aqueous CMP slurry composition between a polishing pad and the workpiece, the aqueous CMP slurry composition comprising abrasive particles and Aspartame; and
pressing the polishing pad and the workpiece together with the CMP slurry composition disposed therebetween while the polishing pad and the workpiece are moving relative to each other to remove the surface material.

17. The method according to claim 16 wherein the abrasive particles are selected from the group consisting of ceria, alumina, silica, copper oxide, iron oxide, nickel oxide, manganese oxide, silicon carbide, silicon nitride, tin oxide, titania, titanium carbide, tungsten oxide, yttria, zirconia, and combinations thereof.

18. The method according to claim 16 wherein the surface material comprises silicon dioxide.

19. A method for removing silicon dioxide from a surface of a workpiece, the method comprising:
providing an aqueous CMP slurry composition between a polishing pad and the surface of the workpiece, the aqueous CMP slurry composition comprising abrasive particles and Aspartame; and
pressing the polishing pad and the surface of the workpiece together with the CMP slurry composition disposed therebetween while the polishing pad and the surface of the workpiece are moving relative to each other.

20. The method according to claim 19 wherein silicon dioxide is removed from the surface of the workpiece at a rate that is at least five times greater than a rate at which silicon nitride is removed from the surface of the workpiece.

21. The method according to claim 19 wherein the presence of the Aspartame in the CMP slurry composition increases a step height removal rate for silicon dioxide as compared to that which would have been obtained if the Aspartame was not included in the CMP slurry composition.

22. The method according to claim 19 wherein the silicon dioxide is removed in an inner layer dielectric (ILD) polishing process.

23. The method according to claim 19 wherein the silicon dioxide is removed in a bulk-oxide-removal polishing step during fabrication of a shallow trench isolation structure.
